(19) United States
(12) Patent Application Publication
(10) Pub. No.: US 2024/0160078 A1
(43) Pub. Date: May 16, 2024

(54) LIGHT SOURCE DEVICE AND REFLECTIVE DISPLAY

(71) Applicant: E Ink Holdings Inc., HSINCHU (TW)

(72) Inventors: Yi-Yu TSAI, HSINCHU (TW); Ching-Huan LIAO, HSINCHU (TW)

(21) Appl. No.: 18/356,208

(22) Filed: Jul. 20, 2023

(30) Foreign Application Priority Data
Nov. 10, 2022 (TW) 111142904

(51) Int. Cl. G02F 1/1677; F21V 8/00; G02F 1/1335

(52) U.S. Cl. CPC G02F 1/1677; G02B 6/0066; G02B 6/009; G02F 1/133616

(57) ABSTRACT

A light source device includes a light emitting element and a fluorescent portion. The light emitting element is configured to emit light. The fluorescent portion is disposed on the light emitting element. The fluorescent portion is configured to transform the light into illumination light. In the spectrum of the illuminating light, the energy in red band is in a range from 25% to 45% of the energy in full band.

### RELATED APPLICATION

This application claims priority to Taiwan Application Serial Number 111142904, filed Nov. 10, 2022, which is herein incorporated by reference in its entirety.

### BACKGROUND

### Field of Invention

The present disclosure relates to a light source device and a reflective display.

### Description of Related Art

In general, a reflective display usually includes a front light module and a reflective display panel. For example, the front light module of the reflective display may emit light and make the light incident on a display area of the reflective display panel to display some images. However, when the front light module emits the light with an inappropriate color temperature, it will affect an effect of displaying color images on the reflective display panel. In addition, the light with the inappropriate color temperature emitted by the front light module may increase the production of reactive oxygen species (ROS) in eyes, which is disadvantageous to the protection of the eyes.

### SUMMARY

An aspect of the present disclosure is related to a light source device.

According to one embodiment of the present disclosure, a light source device includes a light emitting element and a fluorescent portion. The light emitting element is configured to emit light. The fluorescent portion is disposed on the light emitting element. The fluorescent portion is configured to transform the light into illumination light. In the spectrum of the illuminating light, the energy in red band is in a range from 25% to 45% of the energy in full band.

In one embodiment of the present disclosure, the fluorescent portion has a first red fluorescent material, a yellow fluorescent material or a green fluorescent material.

In one embodiment of the present disclosure, the fluorescent portion has a second red fluorescent material, and a bandwidth of the first red fluorescent material is different from a bandwidth of the second red fluorescent material.

In one embodiment of the present disclosure, a color temperature of the illumination light transformed by the fluorescent portion is in a range from 2500 K to 8000 K.

In one embodiment of the present disclosure, a predetermined color temperature of the illumination light transformed by the fluorescent portion is 6500 K.

In one embodiment of the present disclosure, the light source device further includes a flexible circuit board. The flexible circuit board is electrically connected to the light emitting element.

An aspect of the present disclosure is related to a reflective display.

According to one embodiment of the present disclosure, a reflective display includes reflective display panel, a light emitting element and a fluorescent portion. The light emitting element is configured to emit light. The fluorescent portion is disposed on the light emitting element. The fluorescent portion is configured to transform the light into illumination light. In the spectrum of the illuminating light, the energy in red band is in a range from 25% to 45% of the energy in full band.

In one embodiment of the present disclosure, the reflective display further includes a light guide plate. The light guide plate is disposed above the reflective display panel and has a light incident surface and a light emitting surface connected to the light incident surface. The light emitting element and the fluorescent portion face toward the light incident surface of the light guide plate. The reflective display panel faces toward the light emitting surface of the light guide plate.

In one embodiment of the present disclosure, the reflective display panel includes an active device array substrate and a color filter. The color filter is located between the light guide plate and the active device array substrate.

In one embodiment of the present disclosure, the reflective display panel includes a display medium layer. The display medium layer is located between the active device array substrate and the color filter.

In one embodiment of the present disclosure, the fluorescent portion has a first red fluorescent material, a yellow fluorescent material or a green fluorescent material.

In one embodiment of the present disclosure, the fluorescent portion has a second red fluorescent material, and a bandwidth of the first red fluorescent material is different from a bandwidth of the second red fluorescent material.

In one embodiment of the present disclosure, a color temperature of the illumination light transformed by the fluorescent portion is in a range from 2500 K to 8000 K.

In one embodiment of the present disclosure, a predetermined color temperature of the illumination light transformed by the fluorescent portion is 6500 K.

In one embodiment of the present disclosure, the reflective display further includes a flexible circuit board. The flexible circuit board is electrically connected to the light emitting element.

In the embodiments of the present disclosure, the light source device of the reflective display may utilize the configuration of the light emitting element and the fluorescent portion to generate the illumination light of the reflective display, therefore the quality of the colorful images displayed by the reflective display may be improved. In addition, in the spectrum of the illumination light, the energy of the red band is in a range from 25% to 45% of the energy of the full band. When the reflective display displays the colorful images to eyes of users, the production of the blue light and the toxicity of the blue light may be reduced. Therefore, the generation of reactive oxygen species (ROS) of the eyes may be reduced as well, which is advantageous to the protection of the eyes.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1A illustrates a top view of a reflective display according to one embodiment of the present disclosure.

FIG. 1B illustrates a cross-sectional view of the reflective display of FIG. 1A along a line segment 1B-1B.

FIG. 2 to FIG. 5 illustrate cross-sectional views of light source devices according to some embodiments of the present disclosure.

FIG. 6 illustrates a spectrum diagram of the illumination light of FIG. 1A.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Spatially relative terms, such as “beneath,” “below,” “lower,” “above,” “upper,” “front,” “back” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

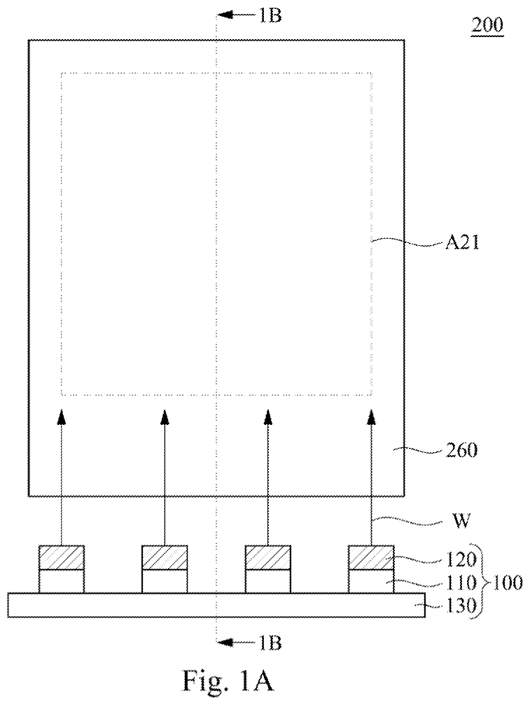

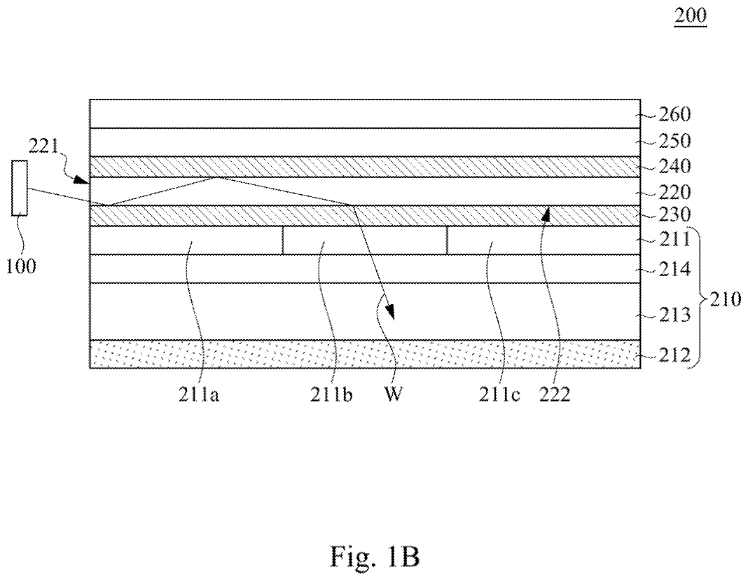

FIG. 1A illustrates a top view of a reflective display 200 according to one embodiment of the present disclosure. FIG. 1B illustrates a cross-sectional view of the reflective display 200 of FIG. 1A along a line segment 1B-1B. referring to both FIG. 1A and FIG. 1B, the reflective display 200 includes a light source device 100 and a reflective display panel 210. In some embodiments, the light source device 100 may generate the illumination light W, and the illumination light W may be incident into a display area A21 of the reflective display panel 210 to display colorful images. In addition, the reflective display panel 210 includes a color filter 211, an active device array substrate 212, a display medium layer 213 and an adhesive layer 214. The display medium layer 213 is located between the active device array substrate 212 and the adhesive layer 214. The adhesive layer 214 is located between the display medium layer 213 and the color filter 211. The color filter 211 may have filters with different colors. For example, the color filter 211 may include a red filter 211a, a green filter 211b, and a blue filter 211c, and the red filter 211a, the green filter 211b, and the blue filter 211c may be arranged in a matrix. When the illuminating light W is incident on the reflective display panel 210, the illuminating light W may pass through the red filter 211a, the green filter 211b and the blue filter 211c to generate red light, green light and blue light.

In some embodiments, the active device array substrate 212 may include pixel electrodes (not shown) and active devices (not shown) electrically connected to the pixel electrodes. For example, the active device may be a thin film transistor (TFT). The reflective display panel 210 may be an electrophoretic display panel (EPD). In addition, the display medium layer 213 may include microcapsules and electrophoretic inks contained in the microcapsules. The active device may control an input voltage of the pixel electrode to generate an electric field in the display medium layer 213 and then may control the microcapsules in the display medium layer 213 to make the reflective display 200 display the colorful images.

In some embodiments, the reflective display 200 further includes a light guide plate 220, a first optical adhesive 230 and a second optical adhesive 240. The light guide plate 220 is disposed above the reflective display panel 210 and located between the first optical adhesive 230 and the second optical adhesive 240. For example, the first optical adhesive 230 and the second optical adhesive 240 of the reflective display 200 may be disposed on opposite surfaces of the light guide plate 220 respectively, and the second optical adhesive 240 may be located between the light guide plate 220 and a touch panel 250, so that the touch panel 250 may be disposed on the light guide plate 220 by the second optical adhesive 240.

In addition, the light guide plate 220 has a light incident surface 221 and a light emitting surface 222 connected to the light incident surface 221. The light incident surface 221 of the light guide plate 220 may be a lateral surface of the light guide plate 220, and the light emitting surface 222 of the light guide plate 220 may be a bottom surface of the light guide plate 220. The light emitting element 110 and the fluorescent portion 120 of the light source device 100 are disposed to face toward the light incident surface 221. The reflective display panel 210 is disposed to face toward the light emitting surface 222. When the light source device 100 emits the illumination light W, the illumination light W may be incident from the light incident surface 221 of the light guide plate 220, so that the illumination light W may transmit to the light guide plate 220. Then, the illuminating light W transmitted in the light guide plate 220 may exit from the light emitting surface 222 of the light guide plate 220, so that the illuminating light W may transmit to the reflective display panel 210 to display the colorful images.

In some embodiments, the reflective display 200 may be a touch display, and the reflective display 200 may include the touch panel 250. The touch panel 250 may be disposed on the second optical adhesive 240. In addition, the reflective display 200 further includes a protection layer 260 covering the touch panel 250. For example, the protection layer 260 may be made of a material that includes glass, but it is not limited in this regard.

In some embodiments, the light source device 100 includes the light emitting element 110, the fluorescent portion 120, and a flexible circuit board 130 (FPC). The flexible circuit board 130 of the light source device 100 can be electrically connected to the light emitting element 110, and the light emitting element 110 and the fluorescent portion 120 can be disposed on the flexible circuit board 130. For example, the light source device 100 may be called a light bar.

Particularly, the light source device 100 of the reflective display 200 may utilize the configuration of the light emitting element 110 and the fluorescent portion 120 to generate the illumination light W of the reflective display 200, therefore the quality of the colorful images displayed by the reflective display 200 may be improved. In addition, in the spectrum of the illumination light W, the energy of the red band is in a range from 25% to 45% of the energy of the full band. When the reflective display 200 displays the colorful images to eyes of users, the production of the blue light and the toxicity of the blue light may be reduced. Therefore, the generation of reactive oxygen species (ROS) of the eyes may be reduced as well, which is advantageous to the protection of the eyes.

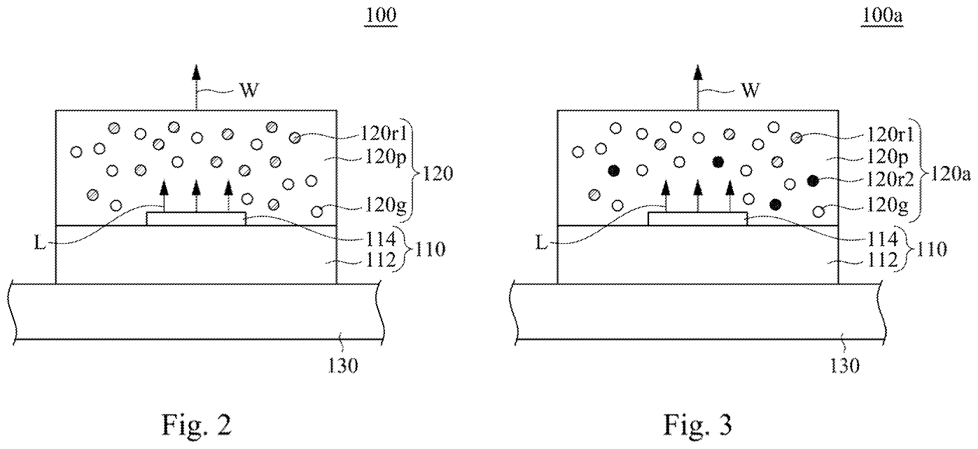

FIG. 2 to FIG. 5 illustrate cross-sectional views of the light source device 100, a light source device 100a, a light source device 100b and a light source device 100c according to some embodiments of the present disclosure. Referring to FIG. 2, the light emitting element 110 of the light source device 100 may include a packaging substrate 112 and a light emitting chip 114. For example, the light emitting chip 114 may be a light emitting diode die (LED Die), and the light emitting chip 114 may be disposed on the packaging substrate 112 by wire bonding or flip chip. The fluorescent portion 120 of the light source device 100 may be disposed on the light emitting element 110 and cover the light emitting chip 114 of the light emitting element 110.

In some embodiments, the fluorescent portion 120 of the light source device 100 includes a transparent package 120p, a first red fluorescent material 120r1 and a green fluorescent material 120g. The first red fluorescent material 120r1 and the green fluorescent material 120g are distributed in the transparent package 120p, and the transparent package 120p may be made of a material that includes polymer materials such as resin. In this embodiment, the light emitting element 110 may emit light L, and the light L may be blue light. The fluorescent portion 120 may transform the light L into the illumination light W with a color temperature. In other words, the illumination light W may be the light L when passing through the green fluorescent material 120g and the first red fluorescent material 120r1. In addition, the color temperature of the illumination light W transformed by the fluorescent portion 120 is in a range from 2500 K to 8000 K, and a predetermined color temperature of the illumination light W is 6500 K.

Referring to FIG. 3, a fluorescent portion 120a of the light source device 100a includes the transparent package 120p, the green fluorescent material 120g, the first red fluorescent material 120r1 and a second red fluorescent material 120r2. The green fluorescent material 120g, the first red fluorescent material 120r1 and the second red fluorescent material 120r2 of the fluorescent portion 120a are distributed in the transparent package 120p, and the transparent package 120p may be made of a material that includes polymer materials such as resin. In this embodiment, the fluorescent portion 120a may transform the light L into the illumination light W with a color temperature. That is to say, the illumination light W may be the light L when passing through the green fluorescent material 120g, the first red fluorescent material 120r1 and the second red fluorescent material 120r2. In addition, the color temperature of the illumination light W transformed by the fluorescent portion 120a is in a range from 2500 K to 8000 K, and a predetermined color temperature of the illumination light W is 6500 K. It is noted that a bandwidth of the first red fluorescent material 120r1 is different from a bandwidth of the second red fluorescent material 120r2, so the light L passing through the first red fluorescent material 120r1 and the second red fluorescent material 120r2 may have different color temperature. For example, the second red fluorescent material 120r2 may be KSF phosphor.

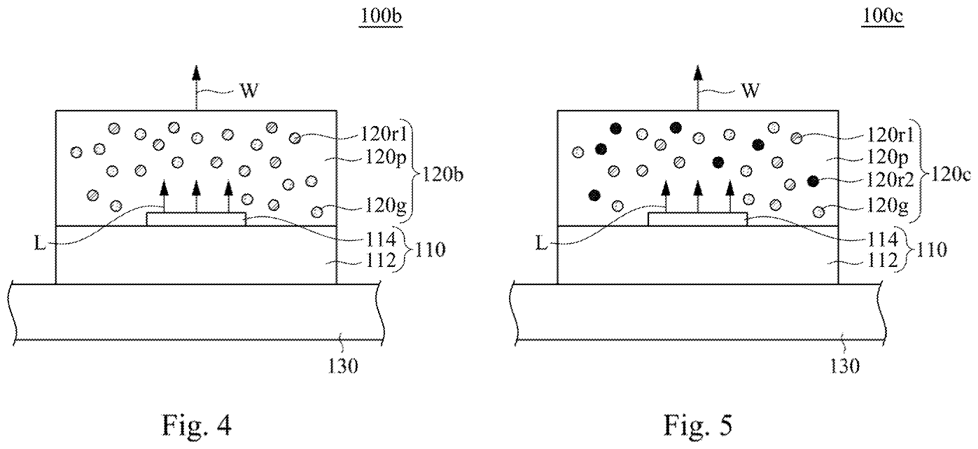

Referring to FIG. 4, a fluorescent portion 120b of the light source device 100b includes the transparent package 120p, the first red fluorescent material 120r1 and a yellow fluorescent material 120y. The first red fluorescent material 120r1 and the yellow fluorescent material 120y are distributed in the transparent packaging 120p. In this embodiment, the fluorescent portion 120b can transform the light L into the illumination light W with a color temperature. That is to say, the illumination light W may be the light L when passing through the yellow fluorescent material 120y and the first red fluorescent material 120r1. In addition, the color temperature of the illumination light W transformed by the fluorescent portion 120b is in a range from 2500 K to 8000 K, and a predetermined color temperature of the illumination light W is 6500 K.

Referring to FIG. 5, a fluorescent portion 120c of the light source device 100c includes the transparent package 120p, the yellow fluorescent material 120y, the first red fluorescent material 120r1 and the second red fluorescent material 120r2. The yellow fluorescent material 120y, the first red fluorescent material 120r1 and the second red fluorescent material 120r2 of the fluorescent portion 120c are distributed in the transparent package 120p, and the transparent package 120p may be made of a material that includes polymer materials such as resin. In this embodiment, the fluorescent portion 120c may transform the light L into the illumination light W with a color temperature. That is to say, the illumination light W may be the light L when passing through the yellow fluorescent material 120y, the first red fluorescent material 120r1 and the second red fluorescent material 120r2. In addition, the color temperature of the illumination light W transformed by the fluorescent portion 120c is in a range from 2500 K to 8000 K, and a predetermined color temperature of the illumination light W is 6500 K. In addition, a bandwidth of the first red fluorescent material 120r1 is different from a bandwidth of the second red fluorescent material 120r2, so the light L passing through the first red fluorescent material 120r1 and the second red fluorescent material 120r2 may have different color temperatures. For example, the second red fluorescent material 120r2 may be KSF phosphor.

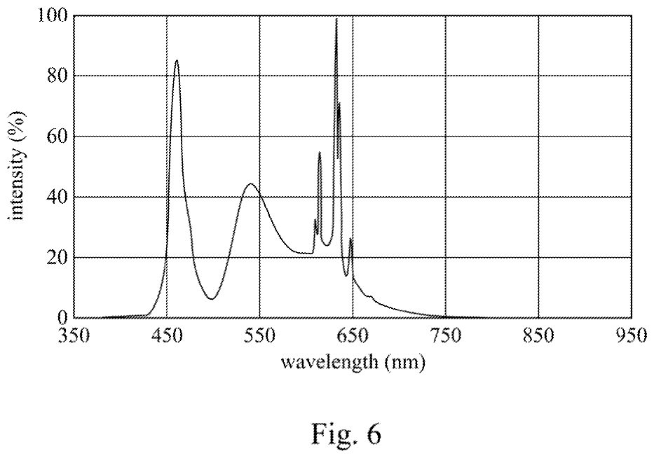

FIG. 6 illustrates a spectrum diagram of the illumination light W of FIG. 1A. Referring to both FIG. 1A and FIG. 6, a full wavelength range of the illumination light W transformed by the fluorescent portion 120 of the light source device 100 is in a range from 380 nm to 780 nm, and a red wavelength range of the illumination light W is in a range from 600 nm to 780 nm. In this embodiment, a predetermined color temperature of the illumination light W is 6500 K, and in the spectrum of the illumination light W, the energy of the red band is approximately 25% of the energy of the full band. When the reflective display 200 displays colorful images to the eyes, the design that the energy of the red band is approximately 25% of the energy of the full band may reduce the production of the blue light and blue light toxicity. The reactive oxygen species (ROS) of the eyes may be reduced, which is beneficial to the protection of the eyes.

In summary, the light source device 100 of the reflective display 200 may utilize the configuration of the light emitting element 110 and the fluorescent portion 120 to generate the illumination light W of the reflective display 200, therefore the quality of the colorful images displayed by the reflective display 200 may be improved. In addition, in the spectrum of the illumination light W, the energy of the red band is in a range from 25% to 45% of the energy of the full band. When the reflective display 200 displays the colorful images to eyes of users, the production of the blue light and the toxicity of the blue light may be reduced. Therefore, the generation of reactive oxygen species (ROS) of the eyes may be reduced as well, which is advantageous to the protection of the eyes.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A light source device, comprising:
a light emitting element configured to emit a light; and
a fluorescent portion disposed on the light emitting element and configured to transform the light into an illumination light, wherein in a spectrum of the illuminating light, an energy in a red band is in a range from 25% to 45% of the energy in a full band.

2. The light source device of claim 1, wherein the fluorescent portion has a first red fluorescent material, a yellow fluorescent material or a green fluorescent material.

3. The light source device of claim 2, wherein the fluorescent portion has a second red fluorescent material, and a bandwidth of the first red fluorescent material is different from a bandwidth of the second red fluorescent material.

4. The light source device of claim 1, wherein a color temperature of the illumination light transformed by the fluorescent portion is in a range from 2500 K to 8000 K.

5. The light source device of claim 1, wherein a predetermined color temperature of the illumination light transformed by the fluorescent portion is 6500 K.

6. The light source device of claim 1, further comprising:
a flexible circuit board electrically connected to the light emitting element.

7. A reflective display, comprising:
a reflective display panel;
a light emitting element configured to emit a light; and
a fluorescent portion disposed on the light emitting element and configured to transform the light into an illumination light, wherein in a spectrum of the illuminating light, an energy in a red band is in a range from 25% to 45% of the energy in a full band.

8. The reflective display of claim 7, further comprising:
a light guide plate disposed above the reflective display panel and having a light incident surface and a light emitting surface connected to the light incident surface, wherein the light emitting element and the fluorescent portion face toward the light incident surface of the light guide plate, and the reflective display panel faces toward the light emitting surface of the light guide plate.

9. The reflective display of claim 8, wherein the reflective display panel comprises:
an active device array substrate; and
a color filter located between the light guide plate and the active device array substrate.

10. The reflective display of claim 9, wherein the reflective display panel comprises:
a display medium layer located between the active device array substrate and the color filter.

11. The reflective display of claim 7, wherein the fluorescent portion has a first red fluorescent material, a yellow fluorescent material or a green fluorescent material.

12. The reflective display of claim 11, wherein the fluorescent portion has a second red fluorescent material, and a bandwidth of the first red fluorescent material is different from a bandwidth of the second red fluorescent material.

13. The reflective display of claim 7, wherein a color temperature of the illumination light transformed by the fluorescent portion is in a range from 2500 K to 8000 K.

14. The reflective display of claim 7, wherein a predetermined color temperature of the illumination light transformed by the fluorescent portion is 6500 K.

15. The reflective display of claim 7, further comprising:
a flexible circuit board electrically connected to the light emitting element.
